(19) United States
(12) Patent Application Publication
(10) Pub. No.: US 2026/0238952 A1
(43) Pub. Date: Aug. 13, 2026

(54) Dynamic Spatial Audio Communication

(71) Applicant: Google LLC, Mountain View, CA (US)

(72) Inventor: Sunil Kumar, Cupertino, CA (US)

(21) Appl. No.: 19/474,963

(22) PCT Filed: Apr. 15, 2024
(86) PCT No.: PCT/US2024/024608

§ 371 Date: Oct. 13, 2025

Related U.S. Application Data
(60) Provisional application No. 63/460,545, filed on Apr. 19, 2023.

(51) Int. Cl. H04S 7/00; H04R 1/10; H04R 1/40; H04R 3/12

(52) U.S. Cl. CPC H04S 7/304; H04R 1/1016; H04R 1/403; H04R 3/12; H04R 2420/07

(57) ABSTRACT

Various arrangements are described for performing dynamic spatial audio communications. Inertial measurement unit (IMU) data may be created based on movement of the audio output system. An audio output system can receive, directly from an audio source device, an audio packet via an audio communication link. In response to receiving the audio packet, the audio output system can transmit to the audio source device the IMU data, an acknowledgement, and possibly upstream audio to the audio source device via the audio communication link.

### CROSS-REFERENCE TO RELATED APPLICATION

This application claims the benefit of and priority to U.S. Provisional Application No. 63/460,545, filed on Apr. 19, 2023, and titled “DYNAMIC SPATIAL AUDIO AND SPATIAL VOICE CALL USING BLE,” the content of which is herein incorporated by reference in its entirety for all purposes.

### BACKGROUND

To effectively perform spatial audio output, inertial measurement unit (IMU) data from an audio output system, such as earbuds, needs to be transmitted to an audio source device with low latency in order to allow the IMU data to be used in modifying how audio is output with minimal lag. Audio data can be relatively high bandwidth. When IMU data is transmitted, the amount of bandwidth consumed is increased. Decreasing the total amount of bandwidth consumed for audio and IMU data transmissions can be beneficial, such as to allow for more bandwidth to be available for other uses.

### SUMMARY

Various embodiments are described related to a method for performing dynamic spatial audio communications. In some embodiments, a method for performing dynamic spatial audio communications is described. The method may comprise creating, by an audio output system, inertial measurement unit (IMU) data based on movement of the audio output system. The method may comprise wirelessly receiving, by the audio output system directly from an audio source device, an audio packet via an audio communication link. The method may comprise, in response to successfully receiving the audio packet, wirelessly transmitting, by the audio output system directly to the audio source device, the IMU data and an acknowledgement to the audio source device as a single packet to the audio source device via the audio communication link.

Embodiments of such a method may include one or more of the following features: prior to creating the IMU data, establishing, by the audio output system, a communication session comprising the audio communication link and a control communication link with the audio source device. The wirelessly receiving and the wirelessly transmitting may be performed using short range wireless communications, such as a wireless personal area network communication protocol such as those specified in Bluetooth™ or Bluetooth Low Energy (BLE) protocol standards. The Bluetooth communications may be Bluetooth™ Low Energy (LE) communications, the audio communications may use a connected isochronous stream (CIS) link, and the control communications may use an asynchronous connection-oriented logical transport (ACL) link. IMU data is not transmitted using the ACL link. The CIS link may have a CIS link interval shorter in duration than a latency requirement for transmission of the IMU data. The audio output system may be a pair of true wireless earbuds, at least one of the pair of true wireless earbuds comprising an accelerometer used in creating the IMU data. The audio packet may be addressed to only a primary earbud of the pair of true wireless earbuds. The method may further comprise receiving, by a secondary earbud of the pair of true wireless earbuds, the audio packet addressed to only the primary earbud. The method may further comprise, in response to receiving the audio packet addressed to only the primary earbud, transmitting a second acknowledgment directly to the primary earbud. The single packet transmitted to the audio source device via the audio communication link may further comprise audio data captured using a microphone of the audio output system. As part of establishing the communication session, data may be provided to the audio source device indicative of the audio communication link being used for IMU data transmissions in lieu of the control communication link.

In some embodiments, an audio output system is described. The system may comprise a speaker. The system may comprise a wireless communication interface. The system may comprise an inertial measurement unit (IMU). The system may comprise a processing system that may be in communication with the speaker, wireless communication interface, and IMU. The processing system may be configured to create IMU data based on an inertial measurement received from the IMU. The processing system may be configured to receive, via the wireless communication interface, from an audio source device, an audio packet via an audio communication link. The processing system may be configured to, in response to successfully receiving the audio packet, cause the IMU data and an acknowledgement to be transmitted to the audio source device via the wireless communication interface as a single packet via the audio communication link.

Embodiments of such a system may include one or more of the following features: the speaker, the wireless communication interface, the IMU, and the processing system may be part of a first earbud. The system may further comprise a second earbud that may not be physically connected with the first earbud. The processing system may be further configured to, prior to creating the IMU data, establish a communication session comprising the audio communication link and a control communication link with the audio source device. The wireless communication interface may communicate using Bluetooth Low Energy (LE) communications, the audio communication link may be a connected isochronous stream (CIS) link, and the control communication link may be an asynchronous connection-oriented (ACL) link. No IMU data may be transmitted using the ACL link. The CIS link may have a CIS link interval shorter in duration than a latency requirement for transmission of the IMU data. The first earbud may function as a primary earbud and the audio packet may be addressed to only the primary earbud. The second earbud may be configured to receive the audio packet addressed to only the primary earbud. The second earbud may be configured to, in response to receiving the audio packet addressed to only the primary earbud, transmit a second acknowledgment directly to the primary earbud. The single packet transmitted to the audio source device via the audio communication link further may comprise audio data captured using a microphone of the audio output system.

### BRIEF DESCRIPTION OF THE FIGURES

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an embodiment of a dynamic spatial audio communication system in which a connected isochronous stream (CIS) link is used to transmit IMU data.

FIG. 2 illustrates a block diagram of an embodiment of a dynamic spatial audio communication system.

FIG. 3 illustrates an embodiment of an audio system in which true wireless earbuds communicate with each other in addition to communicating with an audio source.

FIG. 4 illustrates an embodiment of communications between an audio source and earbuds on a CIS link in which IMU data is transmitted by the earbuds to the audio source.

FIG. 5 illustrates another embodiment of communications between an audio source and earbuds on a CIS link in which IMU data is transmitted by the earbuds to the audio source.

FIG. 6 illustrates an embodiment of a method for using a CIS link to transmit IMU data by the earbuds to the audio source.

FIG. 7 illustrates another embodiment of a method for using a CIS link to transmit IMU data by the earbuds to the audio source.

### DETAILED DESCRIPTION

Dynamic spatial audio requires that IMU data from the audio output system, such as earbuds, be transmitted back to the audio source device. This IMU data can be used to determine how the earbuds have moved. This movement is used to determine how audio transmitted to the earbuds for output should be modified. For example, in a videoconference, a user may turn their head in relation to other users that are on-screen. Dynamic spatial audio allows the audio output via the earbuds to be adjusted to account for the user's head movement, such as by adjusting the volume and spatial location of audio for the various on-screen speakers.

Conventionally, IMU data is transmitted by earbuds to the audio source device via an asynchronous connection-orientated logical transport (ACL) link. IMU data, in order to be used to alter output audio, needs to be transmitted to the audio source device with a low latency. In order to reduce the latency of IMU data being provided to the audio source device, the link interval of the ACL link may need to be reduced to a time value such as 20 ms, which can be multiple times lower than it would otherwise need to be for other control data. In this document, “link interval” refers to how frequently an exchange is made using a given communication link. Therefore, a greater link interval results in less bandwidth being consumed. In an arrangement where the ACL link interval is 10 ms and each communication frame is 1.25 ms, a minimum of 12.5% of the available communication bandwidth would be devoted to the ACL link. Throughout embodiments detailed herein, time multiplexing is employed to allow a single radio to perform the communications for the ACL link and CIS link. Therefore, ACL link and CIS link communications need to occur at different times, even if transmitted on different frequencies.

A CIS link is conventionally used for transmitting audio packets and transmitting acknowledgments (“ACKs”) and negative acknowledgements (“NAKs”) indicative of whether an audio packet was properly received or not. As detailed herein, earbuds and the audio source device can be configured such that a CIS link established between earbuds and an audio source can be used to also transmit IMU data, such as for spatial audio. By using the CIS link for transmitting IMU data, the ACL link can be given a much greater link interval, such as 60 ms to 80 ms. By transmitting the IMU data over the CIS link, the total amount of bandwidth used by the CIS link and the ACL link with a longer link interval is less than if an ACL link with a shorter link interval is used to transmit IMU data.

While arrangements detailed herein refer to earbuds and specifically true wireless earbuds, other audio output devices that transmit IMU data in need of low latency can use the embodiments detailed herein. For example, headphones, hearing aids, wireless speakers, and other forms of audio output devices and audio output system may make use of the arrangements detailed herein. One particular form of audio output system that may make use of the embodiments detailed herein are true wireless earbuds. “True wireless earbuds” refer to earbuds that are not physically connected with the audio source and are also not physically connected with each other. That is, a separate wireless earbud is inserted into each of a user's ears. As detailed herein, true wireless earbuds may directly communicate wirelessly with each other.

Embodiments detailed herein may be performed using Bluetooth Low Energy (LE) and LE Audio. Bluetooth LE makes use of ACL and CIS links, as detailed herein. In other arrangements, short-range device-to-device communication protocols, other than Bluetooth LE, may be used to employ the same detailed concepts. Embodiments detailed herein are applicable to arrangements in which the audio output system is only outputting audio, such as music playback or audio output by a game. Embodiments detailed herein are also applicable to arrangements in which the audio output system transmits upstream audio in addition to receiving downstream audio, such as an audio conference, video conference, or phone call.

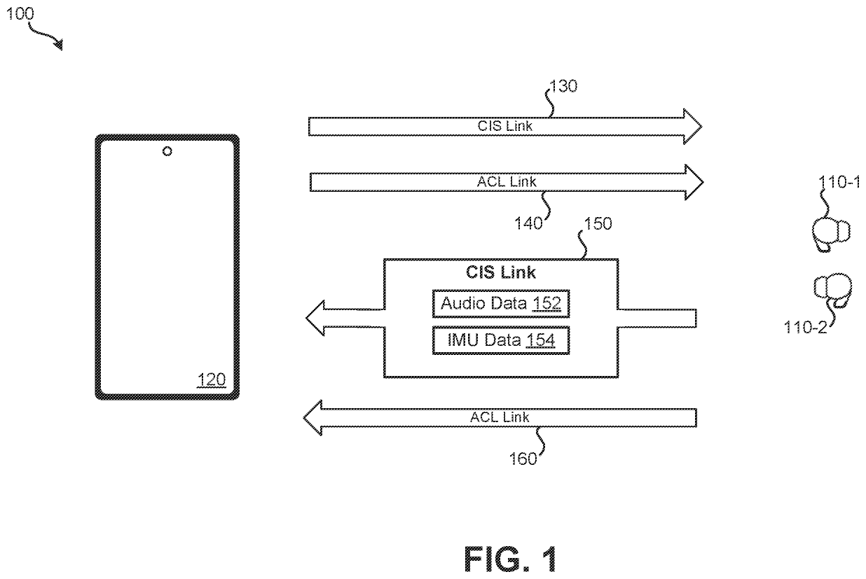

Further detail regarding such arrangements is provided in relation to the figures. FIG. 1 illustrates an embodiment of a dynamic spatial audio communication system 100 (“system 100”) in which a connected isochronous stream (CIS) link is used to transmit IMU data. System 100 can include: true wireless earbuds 110 (110-1, 110-2) and audio source device 120. During creation of an audio session between the earbuds 110 and audio source device 120, multiple links may be created. These links can include: downstream CIS link 130 (that is, from audio source device 120 to earbuds 110); downstream ACL link 140; upstream CIS link 150; and upstream ACL link 160. More generally, outside the context of Bluetooth LE, CIS links can be understood as audio communication sublinks and ACL links can be understood as control sublinks being used for all other data.

In embodiments where true wireless earbuds 110 are used, a single earbud may function as the primary earbud (for example, earbud 110-1). From the perspective of audio source device 120, audio source device 120 is only communicating with the primary earbud. Audio to be output by the secondary earbud (for example, earbud 110-2) may be: obtained by receiving and decrypting communication transmitted by audio source device 120 to the primary earbud, by direct communication with the primary earbud, or some combination thereof. For example, the secondary earbud could attempt to receive the transmission of audio from audio source device 120 to the primary earbud. If it does not successfully receive the audio, the secondary earbud may transmit a request for audio directly to the primary earbud.

ACL link 140 may be used by audio source device 120 to transmit control data to earbuds 110. While audio data may be transmitted using CIS link 130, all other data may be transmitted using ACL link 140. To complement downstream CIS link 130 and downstream ACL link 140, upstream CIS link 150 and upstream ACL link 160 is established. In situations where audio data is only being transmitted downstream, such as music playback, upstream CIS link 150 is still necessary, such as in order to transmit ACKs and NAKs in response to packets received on CIS link 130.

In system 100, CIS link 130 and CIS link 150 have a shorter link interval than ACL link 140 and ACL link 160. CIS link 150 is used to transmit IMU data created by earbuds 110 to audio source device 120. Therefore, in response to an audio packet received on CIS link 130, earbuds 110 transmit a response packet that includes: 1) an ACK (or NAK) in response to the audio packet, which is indicative of whether the audio packet was successfully received or not; and 2) IMU data created by earbuds 110. ACL link 160 is still in existence and is used for other control data and for transmitting ACKs and NAKs in response to data received via ACL link 140. By CIS link 150 having a shorter link interval than ACL link 160, IMU data is delivered to audio source device 120 with lower latency than if ACL link 160 was used.

Audio source device 120 is configured such that it expects to receive IMU data via CIS link 150. During session configuration with earbuds 110, which can occur when earbuds 110 are turned on within wireless communication range of audio source device 120, configuration data can be exchanged between earbuds 110 and audio source device 120 to establish that IMU data 154 will be transmitted on CIS link 150. As such, audio source device 120 has data stored that allows it to properly identify and use IMU data 154 included in CIS link 150. As an example, if upstream audio is being transmitted by earbuds 110 via CIS link 150, audio source device 120 properly routes IMU data 154 separately from audio data 152. Even when upstream audio is not present, audio data 152 is present, which includes ACKs and NAKs to audio packets transmitted via CIS link 130.

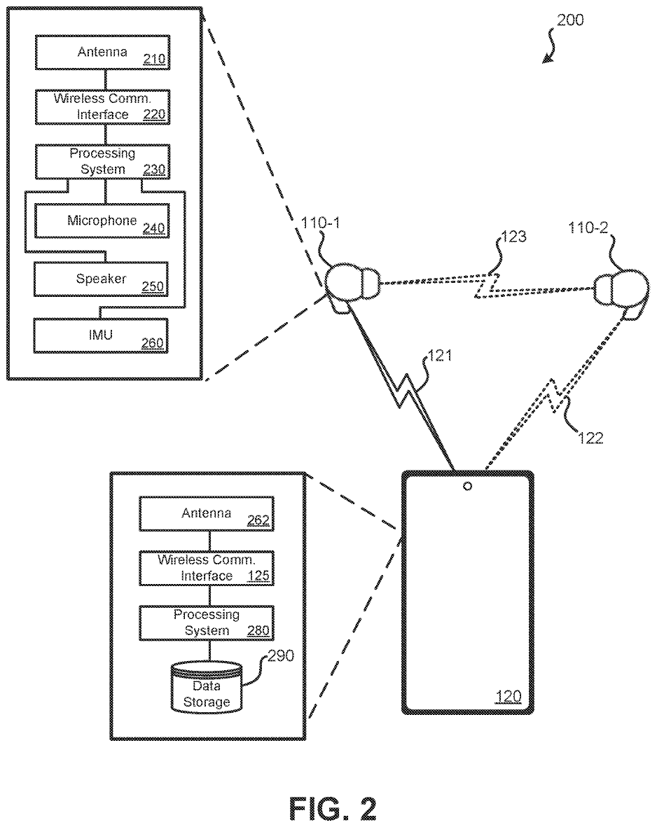

FIG. 2 illustrates an embodiment of a block diagram of a dynamic spatial audio system 200. Dynamic spatial audio system 200 can include earbuds 110 and audio source device 120.

Referring to earbuds 110, components of earbud 110-1 can include: antenna 210; wireless communication interface 220; processing system 230; microphone 240; speaker 250; and inertial measurement unit (IMU) 260. Earbud 110-2 may have the same components or a subset. For example, some pairs of earbuds may include only one earbud that has microphone 240, IMU 260, or both. Antenna 210 can be used for receiving and transmitting device-to-device short-range communications, such as Bluetooth-family communications, including basic rate/extended data rate (BR/EDR), and LE (including LE Audio which uses LE). Wireless communication interface 220 can be implemented as a system on a chip (SOC). Wireless communication interface 220 can include a Bluetooth radio and componentry necessary to convert raw incoming data (e.g., audio data, other data) to Bluetooth packets for transmission via antenna 210. A single radio may be present on each of earbuds 110, thus requiring transmissions, even on different frequencies, to occur at different times. Wireless communication interface 220 may also include componentry to enable one or more alternative or additional forms of wireless communication, both with an audio source and between earbuds.

Processing system 230 may include one or more special-purpose or general-purpose processors. Such special-purpose processors may include processors that are specifically designed to perform the functions of the components detailed herein. Such special-purpose processors may be ASICs or FPGAs which are general-purpose components that are physically and electrically configured to perform the functions detailed herein. Such general-purpose processors may execute special-purpose software that is stored locally using one or more non-transitory processor-readable mediums, such as random-access memory (RAM), and/or flash memory. In some embodiments, processing system 230 and wireless communication interface 220 may be part of a same circuit or SOC.

In some earbuds, microphone 240 may be present. In some embodiments, each of earbuds 110 has a microphone. In other embodiments, only one of earbuds 110 has a microphone. In still other embodiments, no microphone may be present in either of earbuds 110. Audio captured using the one or more microphones of earbuds 110 can be transmitted to audio source device 120. This audio, which can be referred to as “upstream” audio, may include voice, such as for use in a telephone call, video conference, gaming, etc. Various componentry (not illustrated) may be present between wireless communication interface 220, processing system 230, and microphone 240, such as an analog to digital converter (ADC) and an amplifier.

Speaker 250 converts received analog signals to audio. Various componentry (not illustrated) may be present between wireless communication interface 220, processing system 230, and speaker 250, such as a digital to analog converter (DAC) and an amplifier.

IMU 260 can be in the form of an accelerometer, gyroscope, or some other form of sensor that can detect movement or acceleration. IMU 260 may measure a direction of gravity, which can be used to determine the IMU's orientation with respect to the direction of gravity. Side-to-side movement can be detected based on acceleration.

Various components of earbud 110-1 are not illustrated. In addition to the ADC, DAC, and amplifiers previously mentioned, earbud 110-1 also includes a power storage component, such as one or more batteries, and associated componentry to allow for recharging of the power storage component. Also present is a housing and componentry to hold earbud 110-1 within a user's ear. One or more non-transitory processor readable mediums can be understood as present and accessible by wireless communication interface 125, processing system 230, or both. For instance, such mediums may be used for temporary storage of data (e.g., buffers) and storing data necessary for Bluetooth communication (e.g., encryption keys).

Audio source device 120 can include: antenna 262; wireless communication interface 125; processing system 280; and data storage 290. Antenna 262 can be used for receiving and transmitting Bluetooth-family communications, including BR/EDR, and LE. Wireless communication interface 125 can be implemented as a system on a chip (SOC). Wireless communication interface 125 can include a Bluetooth radio and componentry necessary to convert raw incoming data (e.g., audio data, other data) to Bluetooth packets for transmission via antenna 262. Wireless communication interface 125 can additionally or alternatively be used for one or more other forms of wireless communications. Processing system 280 may include one or more special-purpose or general-purpose processors. Such special-purpose processors may include processors that are specifically designed to perform the functions of the components detailed herein. Such special-purpose processors may be ASICs or FPGAs which are general-purpose components that are physically and electrically configured to perform the functions detailed herein. Such general-purpose processors may execute special-purpose software that is stored locally using one or more non-transitory processor-readable mediums via data storage 290, which can include random access memory (RAM), flash memory, a hard disk drive (HDD) and/or a solid-state drive (SSD). In some embodiments, processing system 280 and wireless communication interface 125 may be part of a same circuit or SOC.

Audio source device 120 can include various other components. For example, if audio source device 120 is a smartphone, various components such as: one or more cameras, a display screen or touch screen, volume control buttons, or other wireless communication interfaces can be present. Examples of audio source device 120 include: a smartphone; a media player; a gaming device; a computer system (e.g., laptop, desktop, server); a smartwatch; any other computerized device or system which uses short-range device-to-device wireless communication to output audio or output dynamic spatial audio.

In embodiments where true wireless earbuds 110 are used, one earbud, such as earbud 110-1, may function as the primary earbud. From the perspective of audio source device 120, audio source device 120 is only communicating with the primary earbud and, thus, only transmissions 121 are present. Audio to be output by the secondary earbud (for example, earbud 110-2) may be: obtained by receiving and decrypting communication transmitted by audio source device 120 to the primary earbud, by direct communication with the primary earbud via transmissions 123, or some combination thereof. In other embodiments, transmissions 122 are performed directly between audio source device 120 and earbud 110-2.

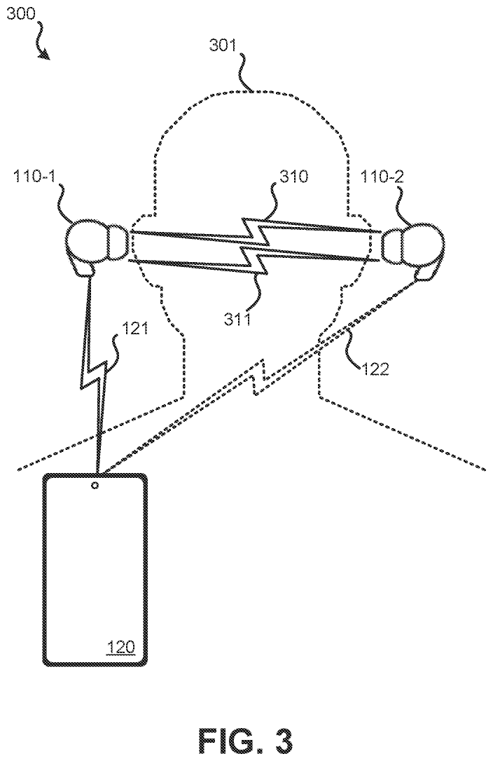

FIG. 3 illustrates an embodiment of an audio system 300 in which true wireless earbuds communicate with each other in addition to communicating with audio source device 120. Earbud 110-1 can perform wireless communications using cross-link 310 with earbud 110-2 and, similarly, earbud 110-2 can perform wireless communications using cross-link 311 with earbud 110-1. This communication may occur via a proprietary link specific to earbuds 110 and therefore can be outside of any Bluetooth family protocol specification; alternatively, a Bluetooth-family communication protocol can be used. The path between earbuds 110, when in use by user 301, is predictable because the distance and the object through which the signals pass (the head of user 301) remain constant. This path can be expected to produce insufficient attenuation to negatively impact communication between earbuds. The path, however, from audio source device 120 to the earbuds is harder to predict since the position of audio source device 120 relative to earbuds 110 can vary substantially and can result in significantly different attenuation at one earbud compared to the other, such as due to cross-body attenuation. Cross-body attenuation is depicted in FIG. 3 by having audio source device 120 closer to earbud 110-1 than earbud 110-2.

Cross-links 310 and 311 can use Bluetooth LE 2M, LE HDT (pending standardization), LE proprietary high data rate modes, classic BR/EDR, or some proprietary communication scheme. Therefore, while Bluetooth-compliant wireless communications occur between earbuds 110 and audio source device 120, communications directly between earbuds do not necessarily need to be compliant with Bluetooth or any other particular communication protocol.

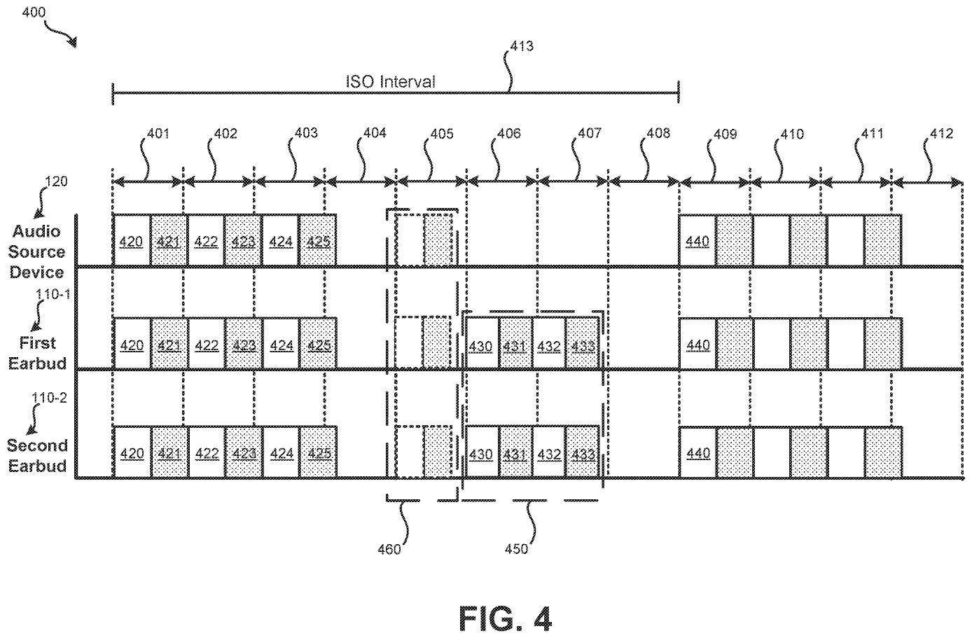

FIG. 4 illustrates an embodiment of a diagram 400 of communications between an audio source and earbuds on a CIS link in which IMU data is transmitted by the earbuds to the audio source. In FIG. 4, two true wireless earbuds 110 are indicated. However, it should be understood that the principles detailed herein can be applied to other forms of audio output systems that transmit IMU data. Further, while FIG. 4 focuses on a discussion on a CIS link that may be specific to Bluetooth LE, other embodiments are applicable to audio communication links used as part of various protocols for device-to-device short-range wireless communications.

In FIG. 4, first earbud 110-1 is functioning as the primary earbud. As such, from the perspective of audio source device 120, audio source device 120 is communicating with only first earbud 110-1. First earbud 110-1 can be either the left or right earbud. Second earbud 110-2 is functioning as the secondary earbud. Second earbud 110-2 has encryption credentials for first earbud 110-1, thus allowing it to successfully receive and decrypt communications intended for first earbud 110-1. Thus, audio data to be output by second earbud 110-2 can be directly received by second earbud 110-2 by “snooping” on transmissions from audio source device 120 to first earbud 110-1.

In FIG. 4, only communication on CIS links between audio source device 120 and earbuds 110 are illustrated. Separate ACL links between audio source device 120 and earbuds 110 are also present. Control data, other than IMU data, is transmitted using the ACL links. All audio data used to output audio is transmitted via the CIS links.

In the example of FIG. 4, the ISO (Isochronous channel) Interval 413 (which is also referred to as the “link interval” herein) is 10 ms, meaning that every 10 ms data is exchanged between audio source device 120 and first earbud 110-1. Each of frames 401-412 (401, 402, 403, 404, 405, 406, 407, 408, 409, 410, 411, and 412) is 1.25 ms in duration, therefore eight frames are 10 ms in duration. The not pictured ACL link can have an ISO interval that is longer than the ISO interval of the CIS link.

Packet 420 is transmitted by audio source device 120 to first earbud 110-1 at the start of frame 401. Packet 420 can be received by first earbud 110-1 and can be received (via snooping) by second earbud 110-2. Packet 420 can include audio data that is to be output by first earbud 110-1, second earbud 110-2, or both.

In response to packet 420, first earbud 110-1 can transmit packet 421. Packet 421 is received by audio source device 120. Packet 421 can include an ACK that packet 420 was properly received or a NAK indicative that packet 420 was not properly received. The ACK or NAK can be included in the packet header. Additionally included in packet 421 is IMU data created by first earbud 110-1, second earbud 110-2, or both.

In response to packet 421, audio source device 120 may transmit packet 422, which includes an ACK or NAK in the header, indicative of whether packet 421 was successfully received by audio source device 120. If packet 420 was successfully received by first earbud 110-1 and packet 421 was successfully received by audio source device 120, no further communication within the ISO interval may be needed between audio source device 120 and first earbud 110-1. However, if any packet was not successfully received (e.g., a NAK was transmitted or no ACK or NAK was received), time is available for retries. As illustrated, packet 422 and packet 424 can include first and second retransmissions of the audio data initially transmitted in packet 420. Packet 423 and packet 425 can include first and second retransmissions of the IMU data initially transmitted in packet 421.

When IMU data is transmitted on the CIS link in response to audio packets, if all of packets 420-425 are transmitted, which can represent a worst-case scenario, the entire exchange can last 4.170 ms. In comparison, if IMU data was not transmitted on the CIS link, this worst-case scenario would last 3.942 ms. The difference in time between arrangements in which IMU data is and is not transmitted is 0.228 ms. When IMU data is not transmitted, four frames are used with ISO interval 413 (due to 3.942 ms being greater than three times the frame duration of 1.25 ms and less than four times the frame duration). Similarly, when IMU data is transmitted, four frames are used within ISO interval 413 (due to 4.170 ms being greater than three times the frame duration of 1.25 ms and less than four times the frame duration). Accordingly, the same number of frames are used regardless of whether IMU data is transmitted.

This transmission of IMU data on the CIS link results in the ACL link being able to have a greater ISO interval. For example, if the ISO interval of the ACL link had been the same as ISO interval 413 (10 ms), one or more frames of frames 405-408, such as frame 405, would need to be reserved for ACL link communications. As illustrated, communications 460 represent a used frame if an ACL link communication had been necessary due to the ACL link having an ISO interval the same as ISO interval 413. Instead, frame 405 is free for other communications and, potentially, for use by other communication protocols and subsystems, such as WiFi.

Packet 440 represents a packet being transmitted by audio source device 120 to first earbud 110-1 during the next ISO Interval. Assuming one of packets 420, 422, and 424 were ACK'ed by first earbud 110-1, audio packet 440 can include new audio data. Subsequent unlabeled packets represent packets in which ACKs or NAKs are transmitted, IMU data is transmitted to audio source device 120, and potential retransmissions of data.

Communications 450 represent direct earbud-to-earbud communications, which can allow data to be relayed between first earbud 110-1 and second earbud 110-2. Further detail regarding earbud-to-earbud communications can be found in U.S. patent application Ser. No. 18/205,346, filed Jun. 2, 2023, entitled “Earbud-to-Earbud Communication Relay,” which is hereby incorporated by reference in its entirety.

If packet 425 was transmitted, the remainder of frame 404 is not available for other communications. Communications between earbuds 110-1 and 110-2 may occur on frame 406 and possibly frame 407. During these communications, audio and/or IMU data may be exchanged. For example, if audio packet 420 was not successfully received by second earbud 110-2 (and no retransmissions of the audio data occurred), second earbud 110-2 can request the portion of the audio data to be output by second earbud 110-2 directly from first earbud 110-1. Alternatively, if audio packet 420 was not successfully received by first earbud 110-1 (and no retransmissions of the audio data occurred because first earbud 110-1 transmitted an ACK to audio source device 120), first earbud 110-1 can request the portion of the audio data to be output by first earbud 110-1 directly from second earbud 110-2. Packets 430, 431, 432, and 433 can represent the earbud-to-earbud communications, which can include retransmissions in case of one or more unsuccessful transmissions.

Additionally, while FIG. 4 was described as an arrangement in which audio data is being streaming to the audio output device (e.g., the earbuds) without audio data being transmitted back, such as for music playback, in other embodiments, upstream audio data may be transmitted. Packet 421 (and, if necessary, packets 423 and 425) can also include audio data captured by a microphone of first earbud 110-1, second earbud 110-2, or both. Therefore, packet 421 can include an ACK (or NAK) in response to packet 420, IMU data, and audio data based on audio received via a microphone of the earbuds.

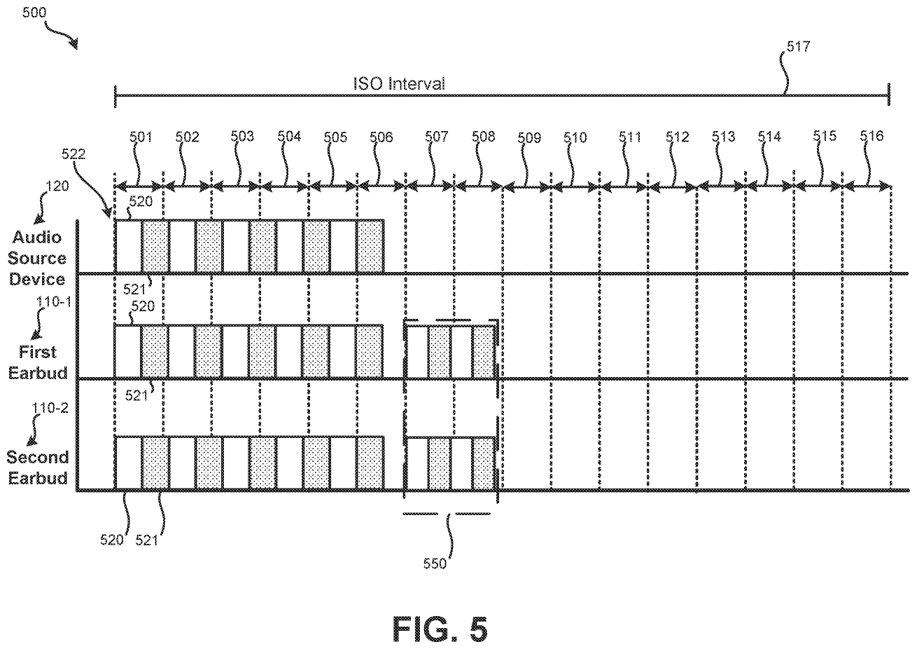

While the example of FIG. 4 uses an ISO interval of 10 ms, in other embodiments, another ISO interval can be used. For example, the ISO interval for the CIS link may be set as 20 ms. FIG. 5 illustrates embodiment 500 of communications between an audio source and earbuds on a CIS link in which IMU data is transmitted by the earbuds to the audio source using an ISO interval 517 of 20 ms. Using a longer CIS interval can have advantages, such as by increasing the amount of time between communications to allow for other unrelated communications, such as WiFi.

In FIG. 5, each of frames 501-516 (501, 502, 503, 504, 505, 506, 507, 508, 509, 510, 511, 512, 513, 514, 515, and 516) is 1.25 ms in duration, therefore sixteen frames are 20 ms in duration. The not pictured ACL link can have an ISO interval that is longer (e.g., 40 ms, 80 ms) than the ISO interval of the CIS link.

Packet 520 is transmitted by audio source device 120 to first earbud 110-1 at the start of frame 501. Packet 520 can be received by first earbud 110-1 and can be received (via snooping) by second earbud 110-2. Packet 520 can include audio data that is to be output by first earbud 110-1, second earbud 110-2, or both.

In response to packet 520, first earbud 110-1 can transmit packet 521. Packet 521 is received by audio source device 120. Packet 521 can include an ACK that packet 520 was properly received or a NAK indicative that packet 520 was not properly received. The ACK or NAK can be included in the packet header. Additionally included in packet 521 is IMU data created by first earbud 110-1, second earbud 110-2, or both. In some embodiments, upstream audio can also be included. Retransmissions, additional audio data and, possibly, IMU data may be transmitted in subsequent packets within ISO interval 517 as detailed in relation to FIG. 4.

When IMU data is transmitted on the CIS link in response to audio packets having an ISO interval 517 of 20 ms, if all of the illustrated packets in packet group 522 are transmitted, which can represent a worst-case scenario, the entire exchange can last 7.05 ms. In comparison, if IMU data was not transmitted on the CIS link, this worst-case scenario would last 6.67 ms. The difference in time between arrangements in which IMU data is and is not transmitted is 0.38 ms. When IMU data is not transmitted, six frames are used within ISO interval 517 (due to 6.67 ms being greater than five times the frame duration of 1.25 ms and less than six times the frame duration). Similarly, when IMU data is transmitted, six frames are used within ISO interval 517 (due to 7.05 ms being greater than five times the frame duration of 1.25 ms and less than six times the frame duration). Accordingly, the same number of frames are used regardless of whether IMU data is transmitted in a 20 ms ISO interval embodiment.

Communications 550 represent direct earbud-to-earbud communications, which can allow data to be relayed between first earbud 110-1 and second earbud 110-2. Communications between earbuds 110-1 and 110-2 may occur on frame 507 and possibly frame 508. During these communications, audio and/or IMU data may be exchanged. For example, if audio packet 520 was not successfully received by second earbud 110-2 (and no retransmissions of the audio data occurred, second earbud 110-2 can request the portion of the audio data to be output by second earbud 110-2 directly from first earbud 110-1. Alternatively, if audio packet 520 was not successfully received by first earbud 110-1 (and no retransmissions of the audio data occurred because first earbud 110-1 transmitted an ACK to audio source device 120), first earbud 110-1 can request the portion of the audio data to be output by first earbud 110-1 directly from second earbud 110-2.

By using an ISO interval of 20 ms, a large number of consecutive frames may remain open within each ISO interval. These open frames 509-516 can allow for other Bluetooth communications or communications using other communication protocols that overlap in frequency band. Thus, a larger ISO interval may be desirable to provide these larger time gaps for other communications.

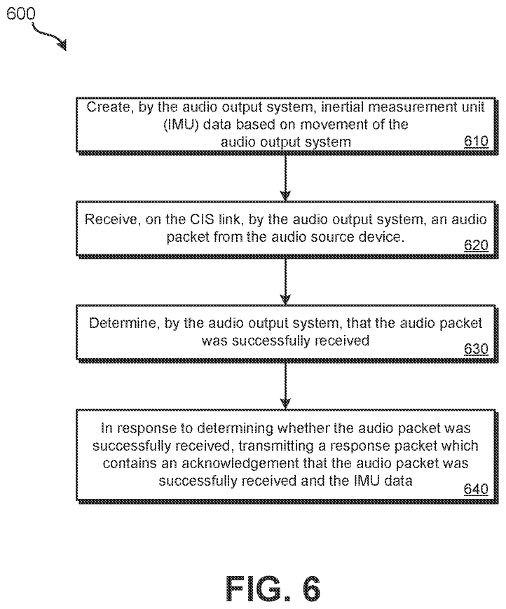

Various methods may be performed using the system and arrangements of FIGS. 1-5. FIG. 6 illustrates an embodiment of a method 600 for using a CIS link to transmit IMU data by the earbuds to the audio source. Method 600 can be performed using an audio output device or system, such as a pair of earbuds, or more specifically, a pair of true wireless earbuds. The audio output device or system transmits IMU data generated onboard the audio output device or system to the audio source device. The audio source device can be any device or system that streams audio data using a device-to-device short-range wireless communication protocol that uses separate audio and control data links, such as Bluetooth LE. The remainder of method 600 refers specifically to Bluetooth LE.

At block 610, IMU data is created by the audio output device. The IMU data is created based on measurements may be an IMU, such as an accelerometer. Another possible form of an IMU can include a gyroscope. If the audio output device is headphones or earbuds, movement of a user's head will influence the IMU data generated. For earbuds, the IMU data may be created by one or both earbuds. If created by both, the IMU data may be averaged or otherwise combined together before transmission. The IMU data is temporarily stored at least until transmitted.

At block 620, the audio source device has transmitted an audio packet to the audio output system via the CIS link. As part of block 640, the audio output system receives the audio packet on the CIS link. In accordance with the Bluetooth LE protocol, for example, the audio source device expects to receive either an ACK or NAK from the audio output system.

At block 630, a determination is made by the audio output device whether an ACK or NAK is to be transmitted in response to the audio packet received on the downstream CIS link. If determined to be properly received by the audio output system, an ACK is to be transmitted; if determined to not be properly received, a NAK is to be transmitted.

At block 640, in response to determining whether the audio packet was successfully received, a packet is transmitted by the audio output device (e.g., the primary earbud) to the audio source device via the upstream CIS link. The packet can include a header that includes either an ACK, if the audio packet was determined to be successfully received, or a NAK, if the audio packet was determined to not be successfully received. As part of this same packet transmitted on the upstream CIS link, the IMU data created at block 610 is transmitted; therefore a single packet includes an ACK (or NAK) to an audio packet and IMU data. (If a spatial voice call, conferencing, or gaming is being performed, the single packet can additionally include voice data based on audio captured using a microphone.) The next audio packet transmitted on the CIS link by the audio source device can include an ACK (or NAK) indicative of whether the packet transmitted by the audio output system was properly received (or not).

In arrangements where two-way audio communications are present, such as during gaming, phone calls, audio conferences, and video conferences, in addition to IMU data being transmitted at block 640, the packet may additionally include audio data created based on audio captured by the audio output device via its microphone.

Separately, control data may be transmitted using the ACL links, which exist concurrently with the CIS links and can operate according to a link interval longer in duration than the link interval of the CIS links. Blocks 610-640 can repeat many times during a given communication session to relay audio to the audio output device, IMU data to the audio source device, and, possibly, audio to the audio source device.

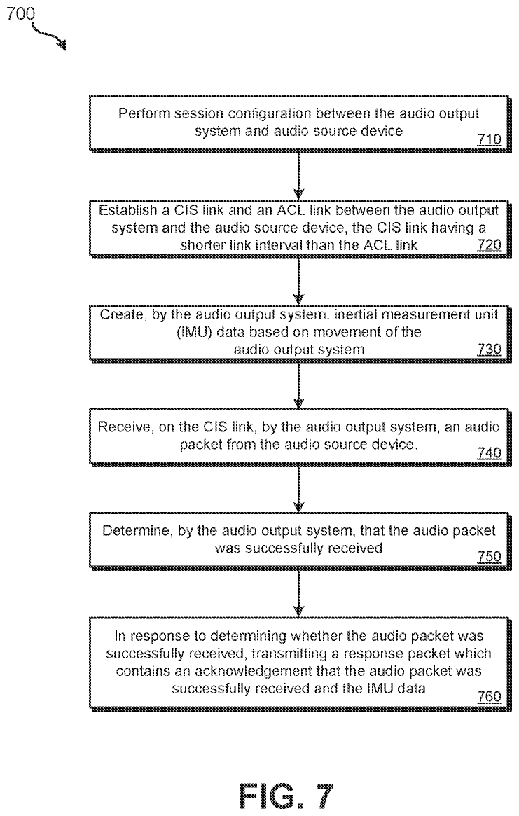

FIG. 7 illustrates an embodiment of a method 700 for using a CIS link to transmit IMU data by the earbuds to the audio source. Method 700 can be performed using an audio output device or system, such as a pair of earbuds, or more specifically, a pair of true wireless earbuds, such as detailed in relation to FIGS. 1-5. The audio output device or system transmits IMU data generated onboard the audio output device or system to the audio source device. The audio source device can be any device or system that streams audio data using a device-to-device short-range wireless communication protocol that uses separate audio and control data links, such as Bluetooth LE. The remainder of method 700 refers specifically to Bluetooth LE.

At block 710, a session configuration is performed between the audio output system and the audio source device. This session configuration may occur whenever audio is to be streamed to the audio output system. For example, when an application is executed on an audio source device that is to perform dynamic spatial audio, a negotiation process between the audio source device and the audio output system can be performed. During this negotiation, the audio source device can be configured to receive IMU data via a CIS link, as opposed to the ACL link.

For true wireless earbuds, as previously detailed, a single communication link between a primary earbud and the audio source device can be established. From the perspective of the audio source device, this is the only communication path. The secondary earbud, however, may be able to receive transmissions made by the audio source device intended for the primary earbud. This arrangement allows the secondary earbud to “snoop” on audio and control data intended for the secondary earbud. To do this, as part of the session configuration (or at some other time) the secondary earbud may obtain encryption credentials from the primary earbud to be able to decrypt communications intended for the primary earbud. Additionally, the secondary earbud and the primary earbud can communicate with each other directly. Therefore, if one of the earbuds did not receive a packet of data from the audio source device, the other earbud can transmit the data from the missed packet to the earbud.

At block 720, the CIS link and the ACL link are established. Separate CIS links may be established in each direction between the audio source device and the audio output device. Separate ACL links may be established in each direction between the audio source device and the audio output device. The link interval of the ACL links match, similarly, the link interval of the CIS links match. The CIS link can be established to have a shorter link interval than the ACL link. For example, the CIS link interval may be 10-20 ms while the ACL link interval may be 70-80 ms.

At block 730, IMU data is created by the audio output device. The IMU data that is created based on measurements may be an IMU, such as an accelerometer. Another possible form of an IMU can include a gyroscope. If the audio output device is headphones or earbuds, movement of a user's head will influence the IMU data generated. For earbuds, the IMU data may be created by one or both earbuds. If created by both, the IMU data may be averaged or otherwise combined together before transmission. The IMU data is temporarily stored at least until transmitted.

At block 740, the audio source device has transmitted an audio packet to the audio output system via the CIS link. As part of block 740, the audio output system receives the audio packet on the CIS link. In accordance with the Bluetooth LE protocol, for example, the audio source device expects to receive either an ACK or NAK from the audio output system.

At block 750, a determination is made by the audio output device whether an ACK or NAK is to be transmitted in response to the audio packet received on the downstream CIS link. If determined to be properly received by the audio output system, an ACK is to be transmitted; if determined to not be properly received, a NAK is to be transmitted.

At block 760, in response to determining whether the audio packet was successfully received, a packet is transmitted by the audio output device (e.g., the primary earbud) to the audio source device via the upstream CIS link. The packet can include a header that includes either an ACK, if the audio packet was determined to be successfully received, or a NAK, if the audio packet was determined to not be successfully received. As part of this same packet transmitted on the upstream CIS link, the IMU data created at block 730 is transmitted; therefore a single packet includes an ACK (or NAK) to an audio packet and IMU data. The next audio packet transmitted on the CIS link by the audio source device can include an ACK (or NAK) indicative of whether the packet transmitted by the audio output system was properly received (or not).

In arrangements where two-way audio communications are present, such as during gaming, phone calls, audio conferences, and video conferences, in addition to IMU data being transmitted at block 760, the packet may additionally include audio data created based on audio captured by the audio output device via its microphone.

Separately, control data may be transmitted using the ACL links, which exist concurrently with the CIS links and can operate according to a link interval longer in duration than the link interval of the CIS links. Blocks 730-660 can repeat many times during a given communication session to relay audio to the audio output device, IMU data to the audio source device, and, possibly, audio to the audio source device.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known, processes, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A method for performing dynamic spatial audio communications, the method comprising:
creating, by an audio output system, inertial measurement unit (IMU) data based on movement of the audio output system;
wirelessly receiving, by the audio output system directly from an audio source device, an audio packet via an audio communication link; and
in response to successfully receiving the audio packet, wirelessly transmitting, by the audio output system directly to the audio source device, the IMU data with an acknowledgement of receipt of the audio packet.

2. The method for performing the dynamic spatial audio communications of claim 1, wherein the IMU data and the acknowledgement are transmitted to the audio source device within a single packet.

3. The method for performing the dynamic spatial audio communications of claim 1, further comprising:
prior to creating the IMU data, establishing, by the audio output system, a communication session comprising the audio communication link and a control communication link with the audio source device.

4. The method for performing the dynamic spatial audio communications of claim 3, wherein the wirelessly receiving and the wirelessly transmitting are performed using short range personal area network communications.

5. The method for performing the dynamic spatial audio communications of claim 4, wherein the audio communication is a connected isochronous stream (CIS) link, and the control communication link is an asynchronous connection-oriented logical transport (ACL) link.

6. The method for performing the dynamic spatial audio communications of claim 5, wherein no IMU data is transmitted using the ACL link.

7. The method of claim 5, wherein the CIS link has a CIS link interval shorter in duration than a latency requirement for transmission of the IMU data.

8. The method for performing the dynamic spatial audio communications of claim 1, wherein:
the audio output system is a pair of true wireless earbuds, at least one of the pair of true wireless earbuds comprising an accelerometer used in creating the IMU data; and
the audio packet is addressed to only a primary earbud of the pair of true wireless earbuds.

9. The method for performing the dynamic spatial audio communications of claim 8, further comprising:
receiving, by a secondary earbud of the pair of true wireless earbuds, the audio packet addressed to only the primary earbud; and
in response to receiving the audio packet addressed to only the primary earbud, transmitting a second acknowledgment directly to the primary earbud.

10. The method for performing the dynamic spatial audio communications of claim 1, wherein the IMU data and the acknowledgement are transmitted to the audio source device via the audio communication link in a data packet including audio data captured using a microphone of the audio output system.

11. The method for performing the dynamic spatial audio communications of claim 3, wherein as part of establishing the communication session, data is provided to the audio source device indicative of the audio communication link being used for IMU data transmissions in lieu of the control communication link.

12. An audio output system, comprising:
a speaker;
a wireless communication interface;
an inertial measurement unit (IMU); and
a processing system, comprising one or more processors, that is in communication with the speaker, wireless communication interface, and IMU, wherein the processing system is configured to:
create IMU data based on an inertial measurement received from the IMU;
receive, via the wireless communication interface, from an audio source device, an audio packet via an audio communication link; and
in response to successfully receiving the audio packet, cause the IMU data and an acknowledgement to the received signal to be transmitted to the audio source device via the wireless communication interface via the audio communication link.

13. The audio output system of claim 12, wherein the IMU data and the acknowledgement are transmitted to the audio source device within a single packet.

14. The audio output system of claim 12, further comprising a second earbud that is not physically connected with the first earbud, wherein the speaker, the wireless communication interface, the IMU, and the processing system are part of a first earbud.

15. The audio output system of claim 12, wherein the processing system is further configured to:
prior to creating the IMU data, establish a communication session comprising the audio communication link and a control communication link with the audio source device.

16. The audio output system of claim 15, wherein the wireless communication interface communicates using connected isochronous stream (CIS) communications link and an asynchronous connection-oriented (ACL) communication link.

17. The audio output system of claim 16, wherein no IMU data is transmitted using the ACL link.

18. The audio output system of claim 16, wherein the CIS link has a CIS link interval shorter in duration than a latency requirement for transmission of the IMU data.

19. The audio output system of claim 14, wherein the first earbud functions as a primary earbud and the audio packet is addressed to only the primary earbud, and wherein the second earbud is configured to:
receive the audio packet addressed to only the primary earbud; and
in response to receiving the audio packet addressed to only the primary earbud, transmit a second acknowledgment directly to the primary earbud.

20. The audio output system of claim 12, wherein the IMU data and the acknowledgement are transmitted to the audio source device via the audio communication link in a packet including audio data captured using a microphone of the audio output system.
